(19) United States
(12) Patent Application Publication
(10) Pub. No.: US 2007/0051261 A1
(43) Pub. Date: Mar. 8, 2007

(54) Manufacturing method for planographic printing plate for color printing

(75) Inventors: Fumikazu Kobayashi, Shizuoka-ken (JP); Toshiharu Masuda, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/514,952

(22) Filed: Sep. 5, 2006

(30) Foreign Application Priority Data
Sep. 5, 2005 (JP) 2005-256563

(51) Int. Cl. B41C 3/08

(52) U.S. Cl. 101/401.1

(57) ABSTRACT

The invention provides a method for forming planographic printing plates for color printing using a plurality of hues. The method includes at least: image-forming using an amplitude modulation screen only for a planographic printing plate used for printing black color used on a first drum of a printing machine; and image-forming using a frequency modulation screen for a planographic printing plate other than the planographic printing plate used for the first drum. The amplitude modulation screen preferably has a dot line number of 300 or less. The frequency modulation screen preferably has a dot size of 30 μm or less. The planographic printing plates prepared in accordance with the method are preferably used for four-color printing of yellow, magenta, cyan and black.

### CROSS-REFERENCE TO RELATED APPLICATION

This application claims priority under 35 USC 119 from Japanese Patent Application No. 2005-256563, the disclosure of which is incorporated by reference herein.

### BACKGROUND OF THE INVENTION

1. Technical Field

The invention relates to a method for producing a planographic printing plate for color printing useful as an offset printing plate. In particular, the invention relates to a method for producing a planographic printing plate for color printing for improving work efficiency of color printing using a frequency modulation screen.

2. Description of Related Art

Improvement of image quality using an array of printing dots has been widely attempted for responding to demand for finely finished printed matter. While a so-called AM (amplitude modulation) screen that displays the intensity of an image by changing the size of dots arranged with an equal space to one another has been hitherto used, the AM screen often causes a problem of deterioration of the image quality by an influence of angular factors of the arrangement of the dots such as moire patterns or rosette patterns when a plurality of screens are overlaid for multi-color printing. Control of these factors is complicated since the angle of each screen corresponding to each hue needs to be adjusted. A frequency modulation screen (FM screen) has been proposed as a means for solving the problem of deterioration of image quality, wherein moire patterns are inhibited from appearing by arranging the dots at random. The intensity of the image is displayed by the FM screen by changing the density of the randomly arranged tiny dots. However, since each dot has a very small area, reproducibility of the dots for producing the printing plate is unstable while control of the plate for printing is difficult. Accordingly, the FM screen is only used in limited applications today irrespective of its advantages.

Lasers and computers have been remarkably improved in recent years. Technical innovation is being advanced in the printing industry using CTP (computer to plate) technology by which printing manuscripts compiled on a computer are directly drawn on a printing plate. Reproducibility of the dots for making a printing plate has been remarkably improved in accordance with the spread of this CTP technology. Planographic printing plates using FM screens are now able to be manufactured rather easily, whereas this was difficult in a PS plate manufactured by using conventional lith films. Consequently, FM screens have come to be more widely used in recent years.

While plate making using fine dots has become easier as described above, difficult problems of control in the printing process, such as defective transfer of the printing ink as described hereinafter, have not been solved yet, and methods for overcoming these problems are desired. When a multi-color image is formed by color printing, a plurality of printing drums on each of which a planographic printing plate is attached are used, and a color image is formed by printing respective hues one after another. However, a so-called inverse trapping tends to occur, in which ink components printed by a preceding drum are transferred onto a blanket of the second drum or thereafter from a printed paper sheet. Accordingly, defective transfer may occur in the second drum and thereafter when a second color is printed on the ink image printed by the first drum due to reverse transfer of the ink component. In full-color printing using four drums of yellow, cyan, magenta and black colors, defective transfer of the ink is remarkable particularly in the final drum (the fourth drum in four-color printing; usually a black color is used on this drum).

This problem is liable to occur as the dots are smaller, or a highly fine image is formed. Specifically, this problem often occurs when an FM screen using a dot size of 30 μm or less is used, and an FM screen using a dot size of 20 μm or less is severely affected. Therefore, the problem of defective transfer of the ink requires urgent resolution.

### SUMMARY OF THE INVENTION

The invention provides a method for manufacturing a planographic printing plate for color printing capable of suppressing defective transfer of the ink caused by transfer of ink components printed by a preceding drum onto the blanket of the second drum or thereafter, particularly onto the blanket of the final drum, during color printing, in order to print a high quality color image on a large number of printing sheets.

The invention has been completed by finding that in order to form a high quality image defective transfer of the ink can be suppressed by selectively using an FM screen, which is important for forming the high quality image, and an AM screen according to the hue to be printed.

Namely, the invention provides a method for forming planographic printing plates for color printing using a plurality of hues, comprising: image-forming using an amplitude modulation screen only for a planographic printing plate used for printing black color used on a first drum of a printing machine; and image-forming using a frequency modulation screen for a planographic printing plate other than the planographic printing plate used for the first drum.

In conventional full color printing, for example, a planographic printing plate for printing cyan, magenta and yellow colors, and other characteristic colors used when necessary, is manufactured using only an FM screen, and only the planographic printing plate used for the first drum, usually a drum for a black printing plate, is manufactured using an AM screen. This method allows the problem of defective color transfer in color printing to be solved without deteriorating the characteristics of the FM screen such as excellent reproducibility of the color, and enables stable printing.

### DETAILED DESCRIPTION OF THE INVENTION

Hereinafter, the present invention is explained in detail.

The method for forming planographic printing plates for color printing using a plurality of hues of the invention is characterized in having at least image-forming using an amplitude modulation screen only for a planographic printing plate used for printing black color used on a first drum of a printing machine; and image-forming using a frequency modulation screen for a planographic printing plate other than the planographic printing plate used for the first drum.

Features of each screen used in the invention for gradation display by controlling the state of the dots will be described hereinafter.

The conventionally used AM screen displays gradation by changing the size of the dots. Dots having the same size are arranged at a constant interval. Accordingly, when a plurality of colored dots are overlaid for multi-color printing, an irregular pattern called a moire pattern may appear due to interference between an original image and images printed thereafter, or a hexagonal pattern called a rosette pattern may appear. Therefore, the angle of the arrangement of the dots is required to be adjusted for printing of each color. However, the above-mentioned problems cannot be completely suppressed even by appropriately adjusting the angle of the dot arrangement. Therefore, in present circumstances, complicated countermeasures are required such as adjusting the printed pattern using a planographic printing plate for printing, among the plural hues, a yellow color having a less obvious hue.

Another means for attaining finer color printing by suppressing irregular printing due to overlap of the dots is to use an increased number of dot lines (dots having a smaller area). However, additional problems may be caused by using a required number of small area dots since the resolution of an output machine (a plate setter) is restricted or print resistance of the small area dots is decreased. For example, in a case of an output machine of 2400 dpi, reproducibility of the dots at a space of 1% of the dot area is theoretically up to 240 lines (240 lines of the dots are aligned within a width of 1 inch (25.4 mm)). If a higher number of dot lines, for example 480 dot lines, are printed, then gradation of the image is expressed in a 4% unit, or 0%, 4%, 8%, 12% and so on, of the dot area, so that reproducibility in a highlighted area is deteriorated and smoothness of the image obtained is lost.

For solving the above-mentioned problems, an FM screen was selected in the invention for obtaining finer color printing. The dot size is not changed in the FM screen; instead gradation is displayed by changing the space of the arrangement of the dots. The effect of the angle of the dot lines is eliminated by randomly arranging the dots, and the problems of the moire pattern and rosette pattern theoretically do not occur.

Computation of the pattern for arranging the dots on an FM screen has been facilitated by the advance of computers, although this was previously considered to be a barrier to manufacturing FM screens. Consequently, the arrangement of the dots can be optimized as a result of precise computation, and the screen has been made easier to use. FM screens are commercially available, and known examples include TAFFETA (trade name; manufactured by Fuji Photo Film Co., Ltd.), STACCATO (trade name; manufactured by Creo Co., LTD.), DIAMOND SCREEN (trade name; manufactured by Heidelberg), SATIN SCREEN (trade name; manufactured by Heidelberg Co.), RANDOT (trade name; manufactured by Dainippon Screen Mfg. Co., Ltd.) and RANDOT X (trade name; manufactured by Dainippon Screen Mfg. Co., Ltd.).

The dot diameter of the FM screen used in the method of the invention is 30 μm or less, preferably in the range of 10 to 30 μm, and more preferably in the range of 20 to 30 μm, for attaining the remarkable effect of the invention in terms of high image quality. When the dot diameter is too small the effect of the invention is not fully manifested and stable reproducibility of the dots as well as printing resistance may be deteriorated.

These FM screens are mainly employed in combination with CTP setters from the manufacturers of corresponding FM screens. Using the CTP enables remarkable improvement of the stable reproducibility of the dots for forming the printing plate and thereby allows a printing plate precursor to be manufactured comparatively simply. Accordingly, a planographic printing plate precursor having a recording layer compatible with CTP is favorably used for the printing drum in the invention as will be described in detail hereinafter.

Using the FM screen enabled a fine dot image to be easily formed as described above. However, a problem when printing is that, as described above, so-called inverse trapping and resultant defective transfer is liable to occur due to transfer of the ink component printed by the preceding drum onto the blankets of the second drum and thereafter from the paper sheet during the color printing process when the dot size is smaller. This problem is highly likely to occur when an AM screen with a number of dot lines of 400 or more is used, or when a FM screen using a dot size of 30 μm or less is used.

In particular, defective transfer of the ink in printing by the planographic printing plates on the second drum or thereafter becomes more evident when using the FM screen than when using the AM screen. Accordingly, a method for enhancing the transferability of a black ink used on the final drum from the printing plate to the blanket has been desired, since the black ink significantly affects the appearance of fine images.

The mechanism of defective transfer is assumed to be as follows. It has been known that the thickness of the ink adhered on a small area image portion such as the dot is reduced when the dot size of the FM screen is reduced, and the amount of the ink transferred onto the paper sheet is also reduced accordingly. Drying speed of the ink increases when the amount of adhesion of the ink is small, undesirable hardening of the ink due to drying takes place on the blanket when the ink is transferred onto the blanket, and it is assumed that the ink is accumulated on the blanket. However, defective transfer may be suppressed in the invention by preventing the ink from accumulating on the blanket due to undesirable hardening by drying, since an image is formed using the AM screen on only the first drum, and the thickness of the ink on the black printing plate that greatly affects the image quality thereafter is increased in the invention.

Usually, the moire pattern and rosette pattern often appear on the picture and gradation portion of clothes by color printing. However, it was shown from the study by the inventors of the invention that the contribution of the black printing plate at light color gradation portions is small. Accordingly, the inventors have considered suppressing inverse trapping on the second drum and thereafter and preventing the ink from accumulating on the blankets of the second drum and thereafter, by using a printing plate on which the image is formed using the AM screen only for the black printing plate in the color printing process. Consequently, images are formed on the planographic printing plates used on the drums except the first drum, specifically on the cyan, magenta, yellow printing plates and specified color plates used on the fourth drum and thereafter, if desired, using the FM screen. The moire pattern and rosette pattern were effectively prevented from appearing by printing the image using the above-mentioned printing plates. Transferability of the ink from the black printing plate to the blanket was greatly improved by forming the image on the black printing plate on the first drum using the AM screen, and both improvement of the image quality, or clear reproduction of the color, and reproducibility of highly fine images could be attained.

Examples of the planographic printing plate precursor attached for use to each drum in the invention include planographic printing plate precursors having a recording layer capable of forming an image by CTP. Specific and favorable examples are a planographic printing plate precursor having a recording layer of a thermal positive type that is able to directly form an image from digital data by exposure to IR laser, where solubility of the exposed portion in an alkaline developer is improved; and a planographic printing plate precursor having a recording layer of a thermal negative type, in which an image is formed by hardening the exposed portion.

The planographic printing plate precursor favorably used in the method for manufacturing the planographic printing plate of the invention will be briefly described below.

Planographic Printing Plate Precursor

The planographic printing plate precursor used in the invention comprises an IR laser sensitive recording layer on a hydrophilic support represented by an aluminum plate.

The positive recording layer comprises a polymer compound insoluble in water and soluble in an aqueous alkaline solution, a dissolution suppressing agent that decreases the solubility of the polymer compound in the aqueous alkaline solution by interacting with the polymer compound, and an IR absorbing agent, if desired. The above-mentioned interaction at an exposed region is released by exposure to the IR laser light, and the planographic printing plate is obtained by developing the exposed recording layer. The recording layer usually comprises an IR absorbing agent such as a cyanin pigment having a dissolution suppressing ability and an alkali-soluble resin.

The negative recording layer comprises a polymerization initiator or an acid generating agent that is able to generate an initiating molecular species such as a radical or an acid by exposure to light, a polymerizable or cross-linking compound, an IR absorbing agent and a binder soluble in an aqueous alkaline solution, if desired. The initiating molecular species is generated at the region exposed to the IR laser, a polymerization reaction occurs or a cross-linked structure is formed at the exposed region to render only the exposed region insoluble in the alkaline developer, and the planographic printing plate is obtained by removing the recording layer at non-exposed regions by subjecting it to development processing.

The planographic printing plate precursor capable of forming an image with the IR laser is widely known in the art, and any planographic printing plate precursor known in the art may be favorably used in the method of the invention. The effect of the invention in terms of the ability to form a highly fine image is expected to be remarkable when a planographic printing plate precursor having a positive recording layer is used.

Preparation of Planographic Printing Plate

The planographic printing plate is manufactured by exposing and developing a planographic printing plate precursor having a recording layer compatible with CTP as described above on a support.

Among the planographic printing plates for printing plural hues, the image formation on the planographic printing plate used for the first drum of a printing machine is conducted using the AM screen, and the image formations on the planographic printing plates other than the planographic printing plate on the first drum are conducted using the FM screen(s). The method for making a black planographic printing plate used on the first drum for color printing will be described first.

The AM screen used for forming the image of the planographic printing plate on the first drum preferably has a dot line number of 300 or less, and more preferably has a dot line number in the range of 150 to 240.

When an AM screen having a dot line number exceeding 300 is used, the area of the dots constituting the screen becomes too small and there is a tendency for the effect of improving transferability to be diminished, and improvement of the image quality to an extent that can be confirmed by visual observation cannot be obtained. For example, when an AM screen having a dot line number of 450 is used for forming an image on the planographic printing plate used on the final drum, the dots constituting the screen are aligned on 450 lines in a space of 25.4 mm. Since the area of each dot is small, any difference of transferability is hardly recognized as compared with transferability using the FM screen, and gradation tends to be insufficiently displayed. Accordingly, it is preferable to use an AM screen with a dot line number of 300 or less for obtaining a sufficient effect for improving transferability of the ink. Using an AM screen having a dot line number in the range of 150 to 240 is more preferable, since gradation is sufficiently displayed, the effect for improving transferability of the ink is evident, and a high quality image is obtained without any evident deterioration of the image quality. In order to form a highly fine image as expected in the invention, it is not appropriate to use an AM screen with an excessively large dot area or, specifically, to use an AM screen with a dot line number of less than 150, for forming the image on the final drum, since the image quality tends to be deteriorated thereby.

A specific example of the method for forming the dots using the AM screen comprises: exposing the planographic printing plate precursor using one of the above-described commercially available AM screens and a CTP setter compatible with data processing with the AM screen; and plate-making by converting (developing) the precursor into a printing plate using an alkaline developer.

While the light source for exposure may be selected depending on the recording layer, a light source having an emission wavelength from the near IR to IR region is preferable as the light source of an active light used for development, and a solid laser or a semiconductor laser is particularly preferable.

An aqueous alkaline solution known in the art may be appropriately selected as a developer or a replenishing liquid. Examples of alkaline reagents used for the aqueous alkaline solution include inorganic alkaline salts such as sodium and potassium silicate, and organic alkaline reagents such as monomethylamine, dimethylamine, trimethylamine, triethanolamine, ethyleneimine or pyridine. One of these reagents may be used alone, or two or more may be used in combination.

The planographic printing plate after being made into the printing plate by development using the developer and replenishing liquid is subjected to post-processing with water, a rinsing liquid containing a surfactant and an inert resin solution containing gum Arabic and a starch derivative, and is used for printing by being attached to the printing drum.

The invention is characterized in that an image is formed using the AM screen only on the planographic printing plate used on the first drum. Specifically, an image is formed on the printing plate attached to the first drum using the AM screen when the image is printed using two colors, while the AM screen is used only for the planographic printing plate on the first drum that is used for printing a black image when printing is full color printing using yellow, magenta, cyan and black colors. When the planographic printing plates for n-colors (n being an integer of 3 or more) are used, images are formed on the planographic printing plates used on the drums except the first drum, or on the drums from the second to the last, using the FM screen. Usually, the first drum is often used for printing using a black ink.

Images are formed in the invention using the FM screen on the planographic printing plates except for the planographic printing plate used on the first drum of the printing machine when a plurality of hues are printed. Specifically, this means that only the planographic printing plate attached to the first drum used for forming the black image is formed using the AM screen in two-color printing, while the planographic printing plates attached to the drums from the second to fourth drums used for yellow, magenta and cyan images, respectively, are formed using the FM screen in full-color printing using the yellow, magenta, cyan and black colors. When n-colors of the planographic printing plates are used (n being an integer of 3 or more), the images are formed on the planographic printing plates used on the drums from second to n-th drums using the FM screen. Since images are formed on these printing plates using the FM screen, there is no possibility of appearance of the moire and rosette patterns when different hues are overlaid by printing.

The FM screens used herein are not particularly restricted and may be appropriately selected and used, so long as the arrangement of the dots has no regularity, dots with a given size are pseudo-randomly arranged, and the intensity of the image is displayed depending on the density of the dots.

The image formed by using an FM screen has advantages of no possibility of appearance of the moire and rosette patterns and, in addition, the image appears to have continuous gradation since the image is formed by tiny dots having the same size, the reproducibility of details is improved, and output of the image is rapid since a printed matter having a resolution comparable to high resolution printing can be obtained even by low resolution printing because reproducibility is excellent at a low recording density region, or at a hypochromic region having a recording density close to the non-image region.

The diameter of a dot is usually in the range of 10 to 75 μm in commercially available FM screens. The effect of the invention in terms of forming a highly fine image is remarkably manifested by using a screen having a dot size of 30 μm or less. The same method as used in the image formation using an AM screen may be used in a specific example of the process for forming the dots using an FM screen of the invention, except for a process for exposing the planographic printing plate precursor using one of the above-mentioned commercially available FM screens, and using a CTP setter compatible with data processing with the FM screen. The exposure and development, and the post-treatment applied thereafter, if desired, are the same as the above-mentioned respective processes. The plural planographic printing plates thus obtained are attached to the respective printing drums of the color printing machine in sequence, and plural sheets of a high quality printed matter can be obtained by printing while inks and aqueous components are supplied by a conventional method.

### EXAMPLES

While the invention is described hereinafter with reference to examples, the scope of the invention is not restricted to these examples.

### Example 1

The planographic printing plate for color printing was manufactured under the following conditions.

A thermal positive CTP plate (trade name: iPRESSO HP-S, manufactured by Fuji Photo Film Co., Ltd.) was used as the planographic printing plate precursor.

Four planographic printing plate precursors were prepared, and one of the precursors was attached to a thermal CTP setter (trade name: LUXEL T-9800CTP, manufactured by Fuji Photo Film Co., Ltd.). The planographic printing plate precursor for black printing was exposed based on data using an AM screen (trade name: FQS 175, 175 lines, manufactured by Fuji Photo Film Co., Ltd.), and was developed with an automatic development machine (trade name: LP-1310HII, manufactured by Fuji Photo Film Co., Ltd.) charged with a developer (trade name: DT-2R, manufactured by Fuji Photo Film Co., Ltd.), a replenishing liquid (trade name: T-2, manufactured by Fuji Photo Film Co., Ltd.) and a finisher liquid (trade name: FG-1, manufactured by Fuji Photo Film Co., Ltd.) and was attached to the first drum to obtain a planographic printing plate used for black printing.

Three planographic printing plate precursors used for cyan, magenta and yellow color printing, respectively, were exposed based on the data using an FM screen (trade name: TAFFETA 20, manufactured by Fuji Photo Film Co., Ltd., dot diameter: 20 μm) corresponding to respective images, and were developed in the same manner as described above to obtain the planographic printing plates used for cyan, magenta and yellow printing.

These four planographic printing plates were attached to the first to final (fourth) drums of a printing machine (trade name: MOV KIKU-HAN size (636×469 mm) FOUR COLOR PRINTER, manufactured by Heidelberg Co.) in the order of black, cyan, magenta and yellow printing plates, and images were printed on a printing sheet (trade name: TOK-HISHI ART 93.5 kg, manufactured by Mitsubishi Paper Mills, Ltd.) by supplying inks (trade name: HY UNITY MZ, manufactured by Toyo Ink Manufacturing Co.) and dampening water (trade name: IF102, 4%, manufactured by Fuji Photo Film Co., Ltd.). DAYGRAPHICA #3000 (trade name, manufactured by InkTec Inc.) was used as an offset blanket. The image was continuously printed, and the number of the printing sheets before a high quality image could not be obtained due to defective adhesion of the ink for the yellow printing plate was counted. The printed matter on the 100th paper sheet was visually observed to confirm appearance of the moire and rosette patterns, if any. The results are shown in Table 1.

### Example 2

Four planographic printing plates of Example 2 were prepared in the same manner as the four planographic printing plates of Example 1 except that an AM screen CORE 300: 300 LINES (trade name, manufactured by Fuji Photo Film Co., Ltd.) was used in place of FQS 175 (described above), and subjected to the evaluation in the same manner as for Example 1. The results are shown in Table 1.

### Comparative Example 1

Four planographic printing plates of Comparative example 1 were prepared in the same manner as the four planographic printing plates of Example 1 except that an FM screen (trade name: TAFFETA 20, manufactured by Fuji Photo Film Co., Ltd.) was used in place of the AM screen FQS 175 (described above) used for the preparation of the planographic printing plates used for black printing, and subjected to the evaluation in the same manner as for Example 1. The results are shown in Table 1.

### Comparative Example 2

Four planographic printing plates of Comparative example 2 were prepared in the same manner as the four planographic printing plates of Example 1 except that an AM screen FQS 175 (described above) was used in place of the FM screen (trade name: TAFFETA 20, described above) used for the preparation of the planographic printing plates used for cyan, magenta and yellow printing, and subjected to the evaluation in the same manner as for Example 1. The results are shown in Table 1.

TABLE 1

| | | | Number of Paper | |
|---|---|---|---|---|
| | | Screen used for | Sheets before | |
| | Screen used for | Cyan, Magenta | Appearance of | |
| | Printing Plate | and Yellow | Defective Adhesion | Moire and |
| | on First Drum | Printing Plates | of INK (×10,000) | Rosette Pattern |
| Example 1 | AM (FQS175) | FM | 2.5 | Did Not Appear |
| | | (TAFFETA20) | | |
| Example 2 | AM | FM | 2.0 | Did Not Appear |
| | (CORE300) | (TAFFETA20) | | |
| Comparative | FM | FM | 1.0 | Did Not Appear |
| Example 1 | (TAFFETA20) | (TAFFETA20) | | |
| Comparative | AM (FQS175) | AM (FGS175) | >3.0 | Appeared |
| Example 2 | | | | |

Table 1 shows that the moire and rosette patterns are suppressed from appearing by printing using the planographic printing plate for color printing obtained by the method for manufacturing the planographic printing plate of the invention, and many sheets of a high quality printed matter can be obtained with good adhesion of the ink. On the other hand, adhesion of the ink was defective on the yellow printing plate at the early stage of printing in the printing plate of Comparative Example 1 on which the image was formed using an FM screen for the black color planographic printing plate used on the first drum, and thus a high quality image could not be obtained. Further, moire and rosette patterns appeared on the image in the printing plate of Comparative Example 2 in which the image was formed using an AM screen for all the planographic printing plates, and thus a high quality image could not be obtained.

### Example 3

The planographic printing plate for color printing was manufactured under the following conditions.

A thermal positive CTP plate (trade name: iPRESSO HP-S, described above) was used as the planographic printing plate precursor.

The planographic printing plate precursor for black printing to be used on the first drum was exposed based on data using an AM screen (trade name: FQS 175, 175 lines, described above). Further, three planographic printing plate precursors used for cyan, magenta and yellow color printing, respectively, were exposed based on the data using an FM screen (trade name: STACCATO 20, manufactured by Creo Inc., dot diameter: 20 μm) corresponding to respective images. These four planographic printing plate precursors were developed to obtain four kinds of planographic printing plates.

The machines used for exposure and development in Example 3 are as follows.

Exposure machine: Thermal CTP setter (trade name: TRENDSETTER 800 QUANTUM, manufactured by Creo Inc.)

Automatic development machine: LP-1310HII (trade name, manufactured by Fuji Photo Film Co., Ltd.)

Developer (trade name: DT-2, manufactured by Fuji Photo Film Co., Ltd.)

Replenishing liquid (trade name: DT-2R, described above)

Finisher liquid (trade name: FG-1, described above)

These four planographic printing plates were attached to the first to final (fourth) drums of a printing machine (trade name: NEW DIA 3F-6, manufactured by Mitsubishi Heavy Industries, Ltd.) in the order of black, cyan, magenta and yellow printing plates, and images were printed on a printing sheet (trade name: RAICHO-TOKU ART 93.5 kg, manufactured by Chuetsu Pulp & Paper Co., Ltd.) by supplying inks (trade name: VALUES-GN, manufactured by Dainippon Ink and Chemicals Inc.) and dampening water (trade name: ECOLITY-1, manufactured by Fuji Photo Film Co., Ltd.). S 7400 (trade name, manufactured by Kinyosha Co., Ltd.) was used as a blanket for a four color printer.

The image was continuously printed, and subjected to the evaluation in the same manner as for Example 1. The results are shown in Table 2.

### Comparative Example 3

Four planographic printing plates of Comparative example 3 were prepared in the same manner as the four planographic printing plates of Example 3 except that an FM screen (trade name: STACCATO 20, described above) was used in place of the AM screen FQS 175 (described above) used for the preparation of the planographic printing plates used for black printing, and subjected to the evaluation in the same manner as for Example 1. The results are shown in Table 2.

TABLE 2

| | | | Number of Paper | |
|---|---|---|---|---|
| | | Screen used for | Sheets before | |
| | Screen used for | Cyan, Magenta | Appearance of | |
| | Printing Plate on | and Yellow | Defective Adhesion | Moire and |
| | First Drum | Printing Plates | of INK (×10,000) | Rosette Pattern |
| Example 3 | AM (FQS175) | FM | 2.5 | Did Not Appear |
| | | (STACCATO20) | | |
| Comparative | FM | FM | 1.0 | Did Not Appear |
| Example 3 | (STACCATO 20) | (STACCATO 20) | | |

Table 2 shows that the moire and rosette patterns are suppressed from appearing by printing using the planographic printing plate for color printing obtained by the method for manufacturing the planographic printing plate of the invention, and many sheets of a high quality printed matter can be obtained with good adhesion of the black ink. On the other hand, adhesion of the ink was defective on the yellow printing plate at the early stage of printing in the printing plate of Comparative Example 3 on which the image was formed using an FM screen for the black color planographic printing plate used on the first drum, and thus printing could not be further continued.

What is claimed is:

1. A method for forming planographic printing plates for color printing using a plurality of hues, comprising:
image-forming using an amplitude modulation screen only for a planographic printing plate used for printing black color used on a first drum of a printing machine; and
image-forming using a frequency modulation screen for a planographic printing plate other than the planographic printing plate used for the first drum.

2. The method of claim 1, wherein the amplitude modulation screen has a dot line number of 300 or less.

3. The method of claim 1, wherein the amplitude modulation screen has a dot line number in the range of 150 to 240.

4. The method of claim 1, wherein the frequency modulation screen has a dot size of 30 μm or less.

5. The method of claim 1, wherein the planographic printing plates are used for two-color printing.

6. The method of claim 1, wherein the planographic printing plates are used for four-color printing of yellow, magenta, cyan and black.
